(19) United States
(12) Patent Application Publication
(10) Pub. No.: US 2011/0080494 A1
(43) Pub. Date: Apr. 7, 2011

(54) IMAGING APPARATUS DETECTING FOREIGN OBJECT ADHERING TO LENS

(75) Inventors: Yukio Mori, Osaka (JP); Kenichi Kikuchi, Kawanishi-shi (JP); Wataru Takayanagi, Ashiya-shi (JP)

(73) Assignee: SANYO ELECTRIC CO., LTD., Osaka (JP)

(21) Appl. No.: 12/894,904

(22) Filed: Sep. 30, 2010

(30) Foreign Application Priority Data
Oct. 2, 2009 (JP) 2009-230219

(51) Int. Cl. H04N 5/228

(52) U.S. Cl. 348/222.1; 348/E05.031

(57) ABSTRACT

An imaging element having an imaging surface on which an optical image of a subject field passing through an optical lens is emitted generates an image signal corresponding to the optical image of the subject field by photoelectric conversion. An aperture mechanism controls an aperture of the optical lens. A shutter controls exposure time for the imaging element. An exposure adjustment unit adjusts an exposure value for the imaging surface based on an evaluation value of brightness of the subject field. A focus adjustment unit adjusts a focus position of the optical lens. A CPU detects a foreign object adhering to the optical lens by performing shooting under a plurality of shooting conditions in which the exposure value and the focus position are identical and aperture values are different from each other, and comparing a plurality of the image signals obtained from the imaging element during the shooting.

This nonprovisional application is based on Japanese Patent Application No. 2009-230219 filed on Oct. 2, 2009 with the Japan Patent Office, the entire contents of which are hereby incorporated by reference.

### BACKGROUND OF THE INVENTION

1. Field of the Invention

The present invention relates to an imaging apparatus, and more particularly to an imaging apparatus having a foreign object detection function for detecting a foreign object adhering to an optical system.

2. Description of the Related Art

As an example of an imaging apparatus having a function of detecting a foreign object adhering to an optical system including a lens, there is a digital camera having an optical component provided to a lens barrel and exposed to the outside, a focus lens focusing a subject image on an image formation position, a drive unit moving the focus lens and adjusting a focus point to obtain a focusing position, a focusing determination unit determining whether or not the focus lens focuses on a surface of the optical component when it is moved, and a notification unit notifying a user of a warning indicating that dirt adheres to the surface of the optical component when the focusing determination unit determines that the focus lens focuses on the surface of the optical component.

According to the digital camera, the focus lens focuses on the surface of the optical component when dirt such as dust adheres to the surface of the optical component, and the focus lens does not focus on the surface of the optical component when no dirt adheres to the surface of the optical component. Since the user is notified of a warning when the focusing determination unit determines that the focus lens focuses on the surface of the optical component, the user can readily check adhesion of dirt and wipe off the dirt with a cleaner or the like, and thereby can avoid continuing shooting with dirt adhering.

Further, a back monitoring apparatus for a vehicle having a camera mounted to a rear portion of the vehicle and a display monitoring an image shot with the camera, configured to include an adhering matter presence/absence detection unit determining the presence or absence of adhering matter on the camera by comparing an actual image of the vehicle shown on a portion of the camera and a reference image corresponding to an actual image in the case where there is no adhering matter on the camera, and detecting whether there is a change in the images, is considered.

However, although the focusing determination unit described above is based on the premise that a focus position of the focus lens is set on the surface of the optical component, such a lens costs high, and the lens itself is large in size. Therefore, there has been a problem that it is difficult to apply the lens to digital cameras that require versatility.

In addition, while the adhering matter presence/absence detection unit described above requires the reference image to determine the presence or absence of adhering matter on the camera, in digital cameras having the premise that shooting is performed at various locations unlike the camera mounted to the rear portion of the vehicle, there are many cases where a subject in the actual image does not match a subject in the reference image. Accordingly, a problem may be caused in the case where the adhering matter presence/absence detection unit is adapted to digital cameras. In particular, once power is off, adhering matter that adheres to a camera during an off period cannot be detected when power is on again, due to change of subjects.

### SUMMARY OF THE INVENTION

According to an aspect of the present invention, an imaging apparatus includes: an imaging unit having an imaging surface on which an optical image of a subject field passing through a lens is emitted, which generates an image signal corresponding to the optical image of the subject field by photoelectric conversion; an aperture control unit which controls an aperture of the lens; a shutter unit which controls exposure time for the imaging unit; an exposure adjustment unit which adjusts an exposure value for the imaging surface based on an evaluation value of brightness of the subject field; a focus adjustment unit which adjusts a focus position of the lens; and a foreign object detection unit which detects a foreign object adhering to the lens by performing shooting under a plurality of shooting conditions in which the exposure value and the focus position are identical and aperture values are different from each other, and comparing a plurality of the image signals obtained from the imaging unit during the shooting.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram showing main portions of a digital camera as an imaging apparatus in accordance with Embodiment 1 of the present invention.

FIG. 2 is a flowchart illustrating foreign object detection processing in accordance with Embodiment 1 of the present invention.

FIG. 3 is a flowchart illustrating the foreign object detection processing in accordance with Embodiment 1 of the present invention.

FIGS. 4A, 4B, 4C are views showing an example of a shot image obtained by shooting/recording processing in step S22 of FIG. 3.

FIGS. 5A, 5B, 5C are views showing an example of a shot image obtained by shooting/recording processing in step S23 of FIG. 3.

FIG. 6 is a view showing an example of a result of comparison between an image 1 and an image 2.

FIG. 7 is a view illustrating foreign object detection processing in accordance with a modification of Embodiment 1 of the present invention.

FIG. 8 is a flowchart illustrating the foreign object detection processing in accordance with the modification of Embodiment 1 of the present invention.

FIG. 9 is a flowchart illustrating foreign object detection processing in accordance with Embodiment 2 of the present invention.

FIG. 10 is a flowchart illustrating foreign object detection processing in accordance with Embodiment 3 of the present invention.

FIG. 11 is a flowchart illustrating the foreign object detection processing in accordance with Embodiment 3 of the present invention.

### DESCRIPTION OF THE PREFERRED EMBODIMENTS

Hereinafter, embodiments of the present invention will be described in detail with reference to the drawings, in which identical or corresponding parts will be designated by the same reference numerals, and the description thereof will not be repeated.

### Embodiment 1

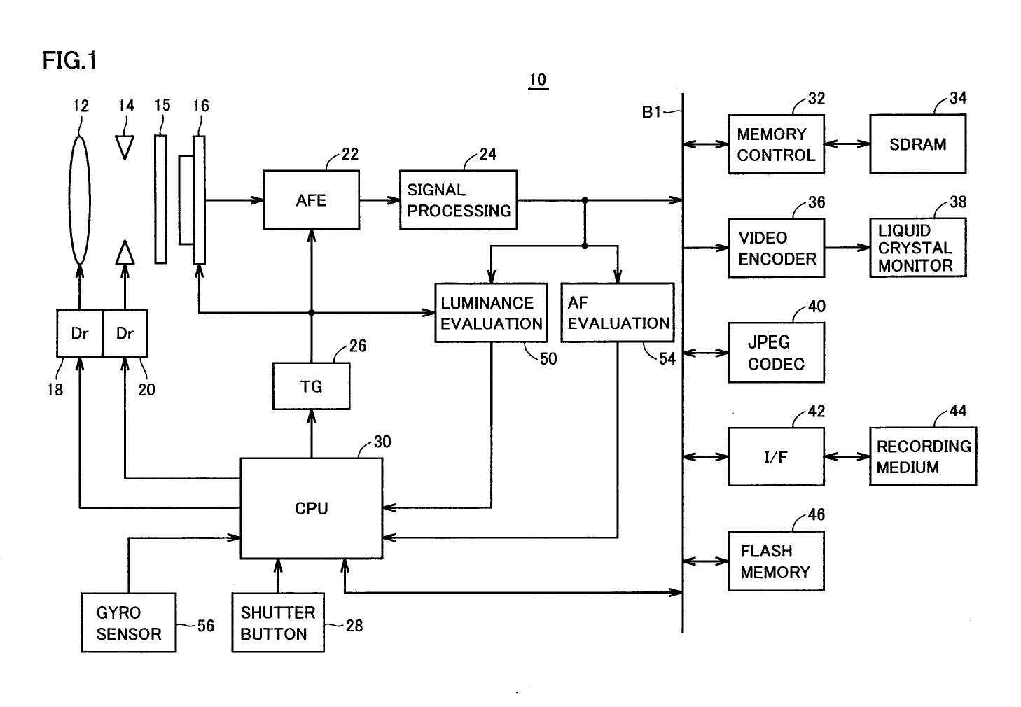

FIG. 1 is a schematic configuration diagram showing main portions of a digital camera 10 as an imaging apparatus in accordance with Embodiment 1 of the present invention.

Referring to FIG. 1, in digital camera 10, an optical image of a subject field is emitted through an optical lens 12 to a light receiving surface, that is, an imaging surface, of an imaging element 16. An aperture mechanism 14 adjusts the amount of light passing through optical lens 12. A shutter 15 adjusts time for which light from the subject field is incident on the imaging surface of imaging element 16 (exposure time). Imaging element 16 generates an electric charge corresponding to brightness/darkness of the optical image of the subject field formed on the imaging surface, that is, a raw image signal, by photoelectric conversion. As imaging element 16, for example, a CCD (Charge Coupled Device) or a CMOS (Complementary Metal-Oxide Semiconductor) is used.

When power is on, through-image processing, that is, processing for displaying a real-time moving image of the subject field on a liquid crystal monitor 38, is performed. Specifically, a CPU (Central Processing Unit) 30 firstly instructs a driver 20 to open aperture mechanism 14, and instructs a TG (Timing Generator) 26 to repeat pre-exposure and pixel decimation reading.

Driver 20 opens an aperture of aperture mechanism 14. TG 26 repeatedly performs pre-exposure for imaging element 16 and pixel decimation reading of the raw image signal thereby generated. The pre-exposure and the pixel decimation reading are performed in response to a vertical synchronization signal generated every 1/30 seconds. Thus, the raw image signal with a low resolution corresponding to the optical image of the subject field is output from imaging element 16 at a frame rate of 30 fps.

An AFE (Analog Front End) circuit 22 performs a series of processing including correlated double sampling, gain adjustment, and A/D (analog to digital) conversion on the raw image signal for each frame output from imaging element 16. Raw image data, which is a digital signal output from AFE circuit 22, is subjected to processing such as white balance adjustment, color separation, and YUV conversion by a signal processing circuit 24, and thereby converted into image data in a YUV format.

Signal processing circuit 24 supplies a predetermined amount of image data to a memory control circuit 32 via a bus B1, and issues a request to write the predetermined amount of image data toward memory control circuit 32. The predetermined amount of image data is written in an SDRAM (Synchronous Dynamic Random Access Memory) 34 by memory control circuit 32. Thus, the image data is stored in SDRAM 34 by the predetermined amount.

A video encoder 36 converts the image data supplied from memory control circuit 32 into a composite video signal conforming to an NTSC (National Television System Committee) format, and supplies the converted composite video signal to liquid crystal monitor 38. As a result, a through-image of the subject field is displayed on a screen of the monitor.

When a shutter button 28 is half depressed, CPU 30 performs AE (Auto Exposure) processing and AF (Auto Focus) processing. The AE processing is performed as described below. Of the image data generated by signal processing circuit 24, Y data is supplied to a luminance evaluation circuit 50. Luminance evaluation circuit 50 evaluates luminance of the subject field every 1/30 seconds based on the supplied Y data. On this occasion, luminance evaluation circuit 50 divides the subject field into multiple portions (for example, into eight portions) in each of a horizontal direction and a vertical direction, and sums the Y data for each of 64 divided areas. As a result, 64 luminance evaluation values Iy[O] to Iy[64] are generated in luminance evaluation circuit 50.

Luminance evaluation values Iy[0] to Iy[64] are captured by CPU 30, and utilized for AE processing for the through-image. CPU 30 adjusts pre-exposure time and an aperture value of aperture mechanism 14 set in TG 26 based on luminance evaluation values Iy[0] to Iy[64]. As a result, brightness of the through-image displayed on liquid crystal monitor 38 is adjusted appropriately.

When shutter button 28 is half depressed, conditions for shooting the image of the subject field are adjusted. CPU 30 performs AE processing for recording. Specifically, CPU 30 captures the latest luminance evaluation values Iy[0] to Iy[64] summed by luminance evaluation circuit 50, and calculates an appropriate exposure value in accordance with the captured luminance evaluation values Iy[0] to Iy[64]. As a result, the exposure value is precisely adjusted in accordance with brightness of the subject field. Then, CPU 30 adjusts optimal exposure time such that the calculated appropriate exposure value can be obtained, and sets the adjusted optimal exposure time in TG 26.

The AF processing is performed as described below. In an AF evaluation circuit 54, high-frequency components of the Y data generated by signal processing circuit 24 are summed for each frame period. CPU 30 captures a summing result, that is, an AF evaluation value (a focusing degree), and controls a driver 18 based on the captured AF evaluation value. As a result, optical lens 12 is set at a focusing position.

When shutter button 28 is fully depressed, CPU 30 performs shooting/recording processing. CPU 30 instructs TG 26 to perform real exposure in accordance with the optimal exposure time and to read all pixels. Imaging element 16 is subjected to real exposure, and all electric charges thereby obtained, that is, the raw image signal with a high resolution, is output from imaging element 16. The output raw image signal is converted by AFE circuit 22 into raw image data, and the converted raw image data is written in SDRAM 34 through signal processing circuit 24. As a result, image data in the YUV format is temporarily stored in SDRAM 34.

When the above processing is completed, CPU 30 subsequently provides instructions to a JPEG (Joint Photographic Experts Group) codec 40 and an I/F (interface) 42. JPEG codec 40 reads the image data stored in SDRAM 34 through memory control circuit 32. The read image data is supplied to JPEG codec 40 via bus B1 and subjected to JPEG compression. The generated compressed image data is supplied to memory control circuit 32 via bus B1, and written in SDRAM 34. I/F 42 reads the compressed image data stored in SDRAM 34 through memory control circuit 32, and records the read compressed image data in a recording medium 44 in a file format.

(Processing Flow)

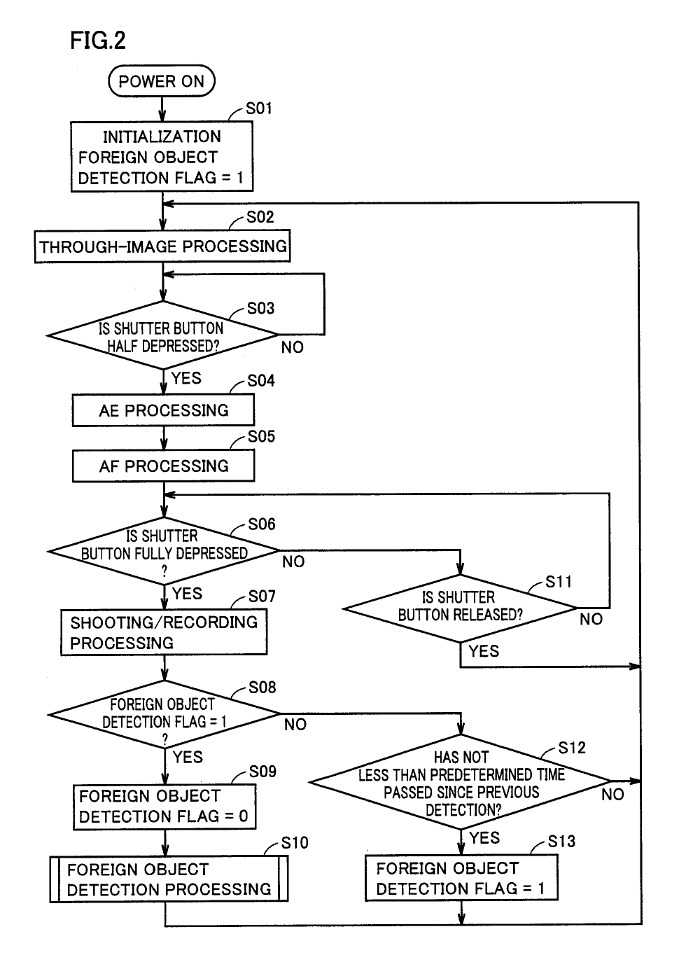

Specifically, CPU 30 performs processing in accordance with a flowchart shown in FIG. 2. A control program corresponding to the flowchart is stored in a flash memory 46.

Referring to FIG. 2, when power is on, initialization is firstly performed (step S01). CPU 30 sets a foreign object detection flag to “1”, and sets the exposure time indicating an initial value in TG 26. CPU 30 also disposes optical lens 12 at an initial position (an end portion at infinity).

Next, CPU 30 performs the through-image processing to display the through-image of the subject field on liquid crystal monitor 38 (step S02). CPU 30 determines whether or not shutter button 28 is half depressed (step S03). If shutter button 28 is not half depressed (NO in step S03), CPU 30 returns to step S03. On the other hand, if shutter button 28 is half depressed (YES in step S03), CPU 30 performs the AE processing (step S04). Specifically, CPU 30 captures the latest luminance evaluation values Iy[0] to Iy[64] summed by the luminance evaluation circuit, and calculates the appropriate exposure value based on the captured luminance evaluation values Iy[0] to Iy[64]. Then, CPU 30 adjusts the optimal exposure time such that the appropriate exposure value can be obtained.

Further, CPU 30 performs the AF processing (step S05). CPU 30 captures the AF evaluation value from AF evaluation circuit 54, and controls driver 18 based on the captured AF evaluation value. Thereby, optical lens 12 is set at the focusing position.

Next, CPU 30 determines whether or not shutter button 28 is fully depressed (step S06). If shutter button 28 is not fully depressed (NO in step S06), CPU 30 determines whether or not shutter button 28 is released (step S11). If the half-depressed state of shutter button 28 is released (YES in step S11), CPU 30 returns to step S02, and if the half-depressed state of shutter button 28 continues (NO in step S11), CPU 30 returns to step S06.

On the other hand, if shutter button 28 is fully depressed (YES in step S06), CPU 30 performs the shooting/recording processing (step S07). Then, CPU 30 determines whether or not the foreign object detection flag indicates “1” (step S08).

If the foreign object detection flag is not “1”, that is, if the foreign object detection flag is “0” (NO in step S08), CPU 30 determines whether or not less than a predetermined time has passed since previous foreign object detection processing was performed (step S12). It is to be noted that the predetermined time is determined beforehand as time defining an interval at which foreign object detection processing is performed.

If not less than the predetermined time has passed since the previous foreign object detection processing was performed (YES in step S12), CPU 30 sets the foreign object detection flag to “1” and returns to step S02. On the other hand, if not less than the predetermined time has not passed since the previous foreign object detection processing was performed (NO in step S12), CPU 30 maintains the foreign object detection flag at “0” and returns to step S02.

In contrast, if the foreign object detection flag is “1” in step S08 (YES in step S08), CPU 30 sets the foreign object detection flag to “0” (step S09) and performs foreign object detection processing for detecting a foreign object adhering to optical lens 12 (step S10).

(Foreign Object Detection Processing)

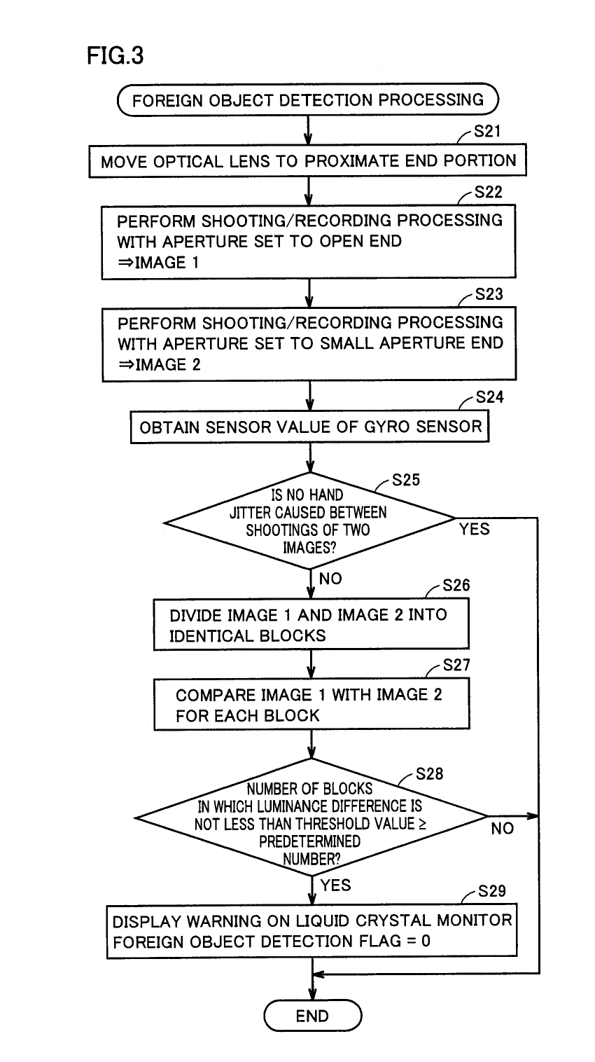

The foreign object detection processing in step S10 follows a subroutine shown in FIG. 3. A control program corresponding to a flowchart of FIG. 3 is stored in flash memory 46.

Referring to FIG. 3, firstly, CPU 30 moves the focus position of optical lens 12 from a current position to a proximate end portion (step S21). Then, shooting is continuously performed in accordance with steps S22, S23 described below, under a plurality of shooting conditions in which a focus position and the exposure value are identical, and different combinations of aperture values and exposure times are used.

Specifically, firstly, CPU 30 instructs driver 20 to open the aperture of aperture mechanism 14. Here, the state of aperture mechanism 14 is represented using a value called an aperture value (F-number). In digital camera 10 in accordance with the present embodiment, the aperture value can be set to a plurality of stages. Of the stages, the stage having the smallest aperture value represents an open end of the aperture, and the stage having the largest aperture value represents a narrowed side (small aperture end) of the aperture. As the aperture value is increased by one stage, the exposure value is decreased. In step S22, the aperture value is set to a value corresponding to the open end.

When the aperture is changed to the open end, the raw image signal based on pre-exposure after the change is output from imaging element 16. CPU 30 captures luminance evaluation values Iy[0] to Iy[64] based on the raw image signal from luminance evaluation circuit 50, and calculates an appropriate exposure value based on the captured luminance evaluation values. Then, the optimal exposure time is adjusted to obtain the calculated appropriate exposure value, and is set in TG 26. When the optimal exposure time is adjusted, CPU 30 performs the shooting/recording processing under the determined shooting conditions (step S22).

In the shooting/recording processing in step S22, the raw image signal with a high resolution output from imaging element 16 is converted by AFE circuit 22 into raw image data, and the converted raw image data is written in SDRAM 34 through signal processing circuit 24. On this occasion, in AFE circuit 22, gain adjustment is performed such that a shot image has optimal brightness. As a result, image data in the YUV format is temporarily stored in SDRAM 34. Hereinafter, the shot image obtained when the aperture is set to the open end will also be referred to as an “image 1” or an “open aperture image”.

Next, CPU 30 instructs driver 20 to narrow the aperture of aperture mechanism 14. In step S23, the aperture value is set to a value corresponding to the small aperture end.

When the aperture is changed to the small aperture end, the raw image signal based on pre-exposure after the change is output from imaging element 16. CPU 30 captures luminance evaluation values Iy[0] to Iy[64] based on the raw image signal from luminance evaluation circuit 50, and adjusts the exposure time based on the captured luminance evaluation values.

On this occasion, CPU 30 adjusts the exposure time such that the exposure value at the time of current shooting is substantially identical to the exposure value at the time of shooting “image 1 (the aperture open image)” in step S22. Specifically, the shooting conditions in step S22 and the shooting conditions in step S23 are set such that they use different combinations of aperture values and exposure times for achieving an appropriate exposure value in accordance with the brightness of the subject field.

When the optimal exposure time is adjusted with the changed aperture, CPU 30 performs the shooting/recording processing under the determined shooting conditions (step S23). Specifically, the raw image signal output from imaging element 16 is converted by AFE circuit 22 into raw image data, and the converted raw image data is written in SDRAM 34 through signal processing circuit 24. On this occasion, in AFE circuit 22, gain adjustment is performed such that a shot image has brightness substantially identical to that of “image 1”. As a result, image data in the YUV format is temporarily stored in SDRAM 34. Hereinafter, the shot image obtained when the aperture is set to the small aperture end will also be referred to as an “image 2” or a “small aperture image”.

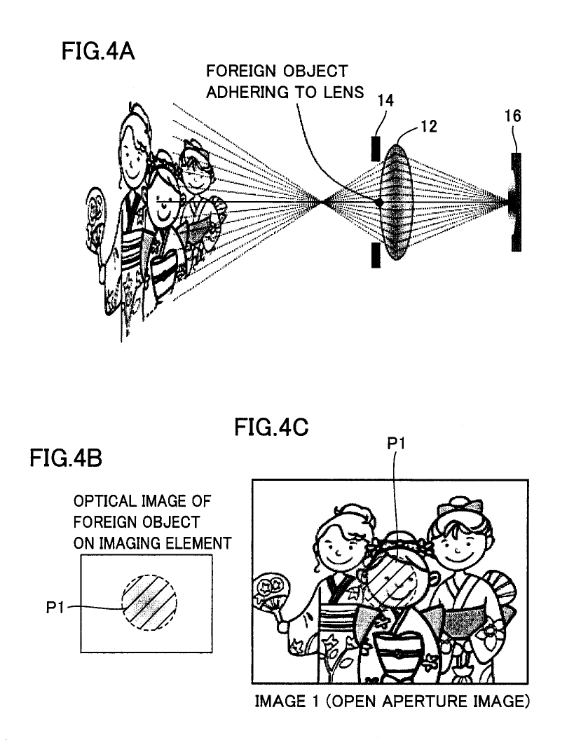

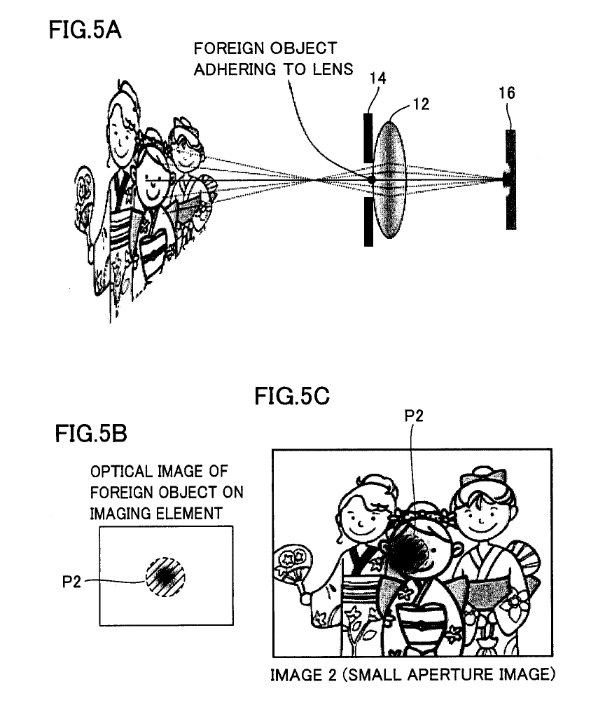

FIGS. 4C and 5C show an example of the shot images obtained in the shooting/recording processing in steps S22, S23 of FIG. 3. It is to be noted that FIG. 4A is a view illustrating the shooting/recording processing in step S22, and FIG. 5A is a view illustrating the shooting/recording processing in step S23.

Referring to FIG. 4A, assume a case where a foreign object adheres to a central portion on a surface of optical lens 12. If a subject field is shot with the focus position of optical lens 12 disposed at the proximate end portion and the aperture set to the open end in such a case, an image of the foreign object appears in a diffused state at a central portion P1 of an optical image of the subject field formed on the imaging surface of imaging element 16 (see FIG. 4B). This is caused because the focusing position of optical lens 12 is not on the surface of optical lens 12. Therefore, as shown in FIG. 4C, a shot image obtained by subjecting the optical image to photoelectric conversion (image 1) is blurred considerably, and some influence of the foreign object can be seen at central portion P1 thereof.

On the other hand, if the subject field is shot with the focus position of optical lens 12 disposed at the proximate end portion and the aperture set to the small aperture end as shown in FIG. 5A, diffusion of the image of the foreign object is suppressed low at a central portion P2 of an optical image of the subject field formed on the imaging surface of imaging element 16 (see FIG. 5B). Therefore, as shown in FIG. 5C, influence of the foreign object seen at central portion P2 of a shot image obtained by subjecting the optical image to photoelectric conversion (image 2) is greater than the influence of the foreign object seen in the shot image (image 1).

Thus, between image 1 and image 2 obtained by shooting the same subject field with the aperture changed between the open end and the small aperture end, there appears a difference in the magnitude of the influence of the foreign object on the shot images. Such a difference is caused because depth of field (a range in which a subject field is visually in focus) varies in accordance with the change in the aperture.

Specifically, since the image shot with the aperture opened to the open end (image 1) has a shallow depth of field, the image appears such that focus is achieved on the focus position only, and the foreign object located in front of the focus position looks completely blurred. Therefore, the foreign object has a small influence on the shot image.

In contrast, since the image shot with the aperture narrowed to the small aperture end (image 2) has a deep depth of field, the image appears such that focus is achieved not only on the focus position but also on the front of the focus position. Therefore, the foreign object in the image looks blurred a little, and thus the foreign object has more influence on the shot image than that on image 1.

Consequently, by utilizing that the influence of the foreign object on the shot image varies in accordance with depth of field, the presence or absence of a foreign object adhering to optical lens 12 can be determined by comparing two images 1 and 2 having different depths of field.

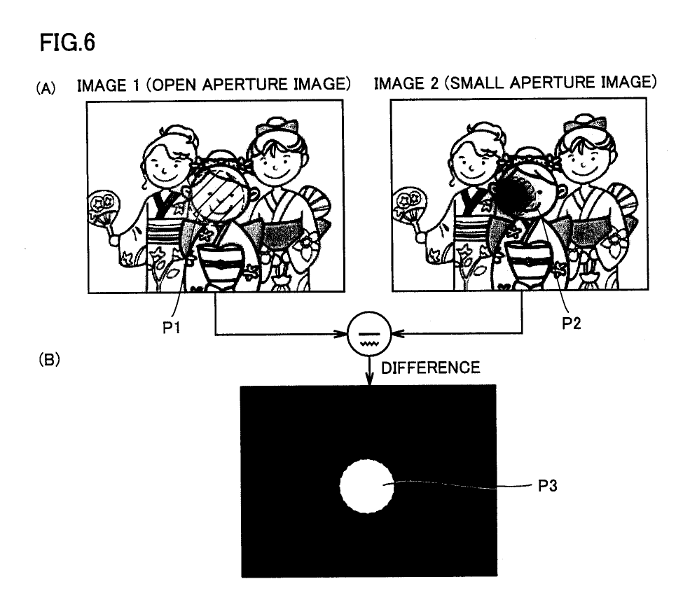

FIG. 6 is a view showing an example of a result of comparison between image 1 and image 2, in which FIG. 6(A) shows image 1 (identical to the image shown in FIG. 4C) and image 2 (identical to the image shown in FIG. 5C), and FIG. 6(B) shows a result of calculating a difference in luminance for each pixel between image 1 and image 2.

As described above, since gain adjustment is performed such that image 1 and image 2 have the same exposure value and the same brightness, the value of the luminance difference for each pixel is essentially substantially zero, which means that no luminance difference is generated. However, in FIG. 6(B), a luminance difference is generated at a central portion P3 in an image due to different influences of the foreign object between the images. Therefore, by detecting whether or not the luminance difference is generated, the presence or absence of a foreign object adhering to optical lens 12 can be determined.

With this configuration, even an ordinary digital camera mounted with a lens not having a focusing position on a surface of the lens can detect a foreign object adhering to the surface of the lens.

Further, since two shot images having the same subject field and exposure value and different depths of field can be obtained by continuously performing shooting with an aperture changed, even in the case where there is a change in a shooting environment after power is off, a foreign object that adheres to a lens during an off period can be detected when power is on again.

It is to be noted that the reason why the present embodiment employs a configuration in which shooting is performed with the aperture changed between the open end and the small aperture end is to maximize the difference in depth of field between the two shot images and thereby to cause a significant difference in the influence of the foreign object on the shot images. Therefore, the aperture is not necessarily limited to be changed to the open end and the small aperture end, as long as the change causes a significant difference in the influence of the foreign object between the two shot images.

Referring to FIG. 3 again, if the shooting/recording processing for image 1 and image 2 is completed (steps S22, S23), CPU 30 obtains a sensor value of a gyro sensor 56 (step S24). Gyro sensor 56 senses hand jitter of a device body of digital camera 10, and outputs the sensed hand jitter amount to CPU 30. In ordinary shooting processing, CPU 30 drives and controls a hand jitter correction mechanism (not shown) to move imaging element 16 in a direction perpendicular to an optical axis of optical lens 12 in accordance with the hand jitter amount sensed by gyro sensor 56. Thereby, the hand jitter correction mechanism moves imaging element 16 to cancel the hand jitter of the device body.

In step S25, CPU 30 determines whether no hand jitter is caused in a period from when image 1 is shot (step S22) to when image 2 is shot (step S23) based on the sensor value of gyro sensor 56. If CPU 30 determines that hand jitter is caused during the period (YES in step S25), CPU 30 terminates the foreign object detection processing.

On the other hand, if CPU 30 determines that no hand jitter is caused during the period (NO in step S25), CPU 30 compares image 1 with image 2, and detects the presence or absence of a foreign object adhering to optical lens 12 based on a comparison result.

Specifically, CPU 30 reads the image data of image 1 and image 2 stored in SDRAM 34 through memory control circuit 32, and divides each of the read image 1 and image 2 into identical predetermined blocks (step S26). Then, CPU 30 compares image 1 with image 2 for each block (step S27). On this occasion, CPU 30 calculates a value of luminance difference between image 1 and image 2 for each block, and compares the calculated luminance difference value with a predetermined threshold value. If the number of blocks in which the luminance difference value is not less than the predetermined threshold value is not less than a predetermined number (YES in step S28), CPU 30 determines that a foreign object adheres to optical lens 12. On the other hand, if the number of blocks in which the luminance difference value is not less than the predetermined threshold value is less than the predetermined number (NO in step S28), CPU 30 terminates the foreign object detection processing.

If CPU 30 determines that a foreign object adheres to optical lens 12, CPU 30 causes liquid crystal monitor 38, via video encoder 36, to display a warning indicating that a foreign object adheres to optical lens 12. Further, CPU 30 resets the foreign object detection flag to “0” (step S29).

It is to be noted that means for notifying a user that a foreign object adheres to optical lens 12 is not limited to a configuration causing liquid crystal monitor 38 to display a warning as described above. For example, a configuration lighting up a warning lamp provided to a device body or a configuration outputting a warning tone from a speaker may be employed.

[Modification]

In Embodiment 1 described above, the presence or absence of a foreign object is determined by calculating a difference between image 1 and image 2 having different depths of field, and determining whether or not the number of blocks in which the difference is not less than a predetermined threshold value is not less than a predetermined number. The presence or absence of a foreign object can also be determined by comparing the luminance evaluation values used to control exposure for image 1 and image 2, as shown in the present modification.

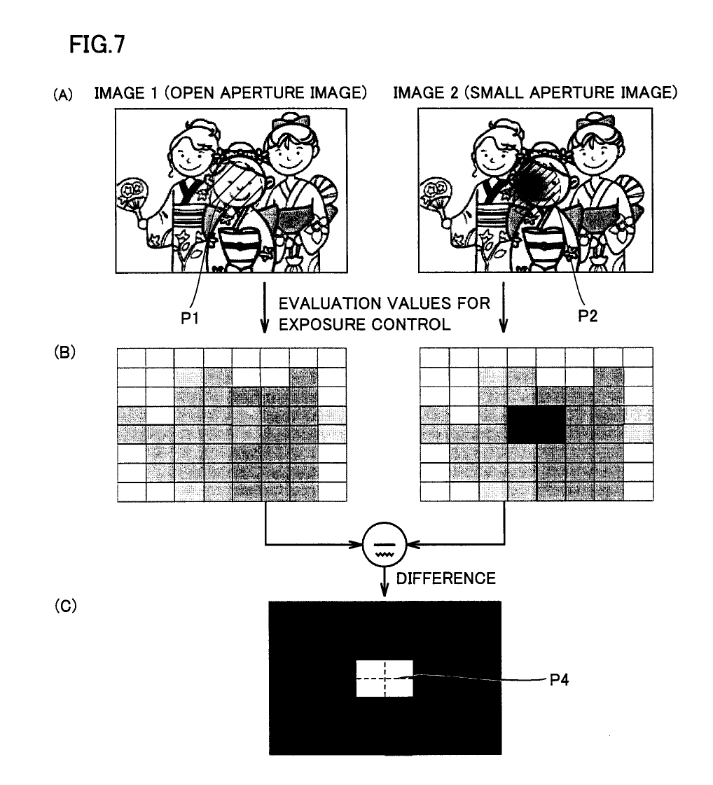

FIG. 7 is a view illustrating foreign object detection processing in accordance with a modification of Embodiment 1 of the present invention, in which FIG. 7(A) shows image 1 (identical to the image shown in FIG. 4C) and image 2 (identical to the image shown in FIG. 5C), and FIG. 7(B) shows the luminance evaluation values used to adjust exposure values for the images. The luminance evaluation values are those generated in luminance evaluation circuit 50 (FIG. 1) and captured by CPU 30 in the AE processing. As shown in FIG. 7(B), luminance evaluation circuit 50 divides the subject field into eight portions in each of the horizontal direction and the vertical direction, sums the Y data for each of 64 divided areas, and thereby generates 64 luminance evaluation values Iy[0] to Iy[64].

FIG. 7(C) shows a result of calculating a difference in the luminance evaluation values for each divided area. FIG. 7(C) shows that a large difference occurs in four divided areas P4 in a central portion of an image. Therefore, the presence or absence of a foreign object adhering to optical lens 12 can be determined by detecting whether or not the difference occurs.

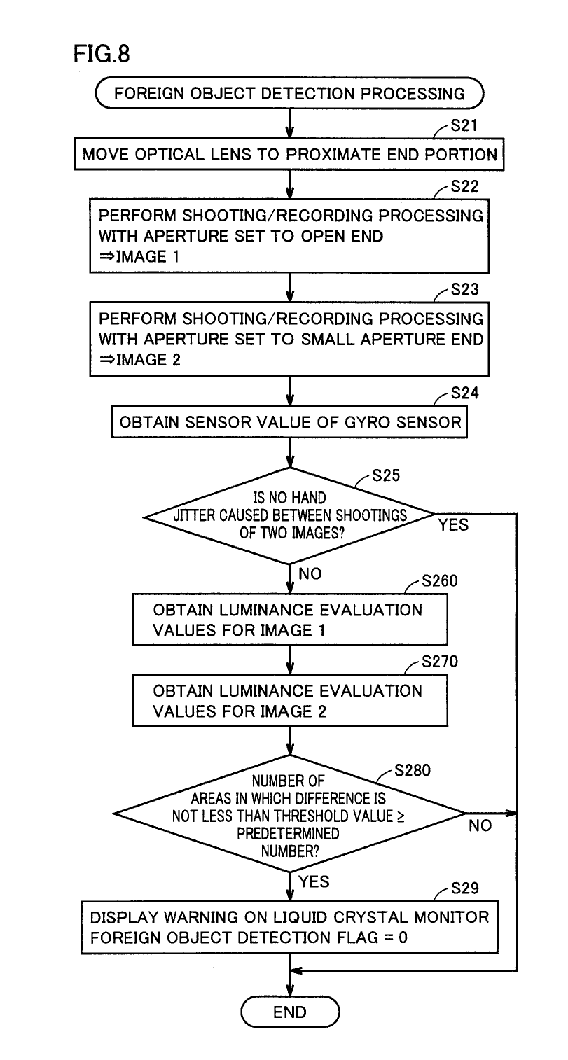

FIG. 8 is a flowchart illustrating the foreign object detection processing in accordance with the present modification. The flowchart of FIG. 8 is different from the flowchart of FIG. 3 only in that steps S26, S27, S28 in the flowchart of FIG. 3 are replaced by steps S260, S270, S280.

In step S25, if CPU 30 determines that no hand jitter is caused in the period from when image 1 is shot (step S22) to when image 2 is shot (step S23), CPU 30 obtains luminance evaluation values Iy[0] to Iy[64] used to adjust the exposure value for image 1 (step S260), and obtains luminance evaluation values Iy[0] to Iy[64] used to adjust the exposure value for image 2 (step S270), from a built-in register. These luminance evaluation values have been registered in the register after the optimal exposure time is adjusted in steps S22, S23.

CPU 30 calculates a value of the difference in the luminance evaluation values for each divided area, and compares the calculated difference value with a predetermined threshold value. If the number of divided areas in which the difference value is not less than the predetermined threshold value is not less than a predetermined number (YES in step S280), CPU 30 determines that a foreign object adheres to optical lens 12. On the other hand, if the number of divided areas in which the difference value is not less than the predetermined threshold value is less than the predetermined number (NO in step S280), CPU 30 terminates the foreign object detection processing.

As described above, according to the foreign object detection processing in accordance with the modification of Embodiment 1 of the present invention, the presence or absence of a foreign object adhering to optical lens 12 is determined by comparing the evaluation values used to control exposure for image 1 and image 2, and thereby processing load on CPU 30 for the foreign object detection processing can be reduced. As a result, detection of a foreign object can be performed in a short time.

### Embodiment 2

In Embodiment 1 described above, image 1 and image 2 having different depths of field are shot in a state where the focus position of optical lens 12 is set beforehand at the proximate end portion. In such a configuration, the subject in the image looks blurred as shown in FIGS. 4C and 5C. Therefore, in the case where a difference in the degree of blurring of the subject between image 1 and image 2 appears as a difference in brightness between the images, there is a possibility that detection of the difference in brightness may lead to an erroneous determination that a foreign object adheres.

In foreign object detection processing in accordance with the present embodiment, as means for preventing such a problem, image 1 and image 2 are shot with the aperture changed in a state where the focus position of optical lens 12 is set on a subject.

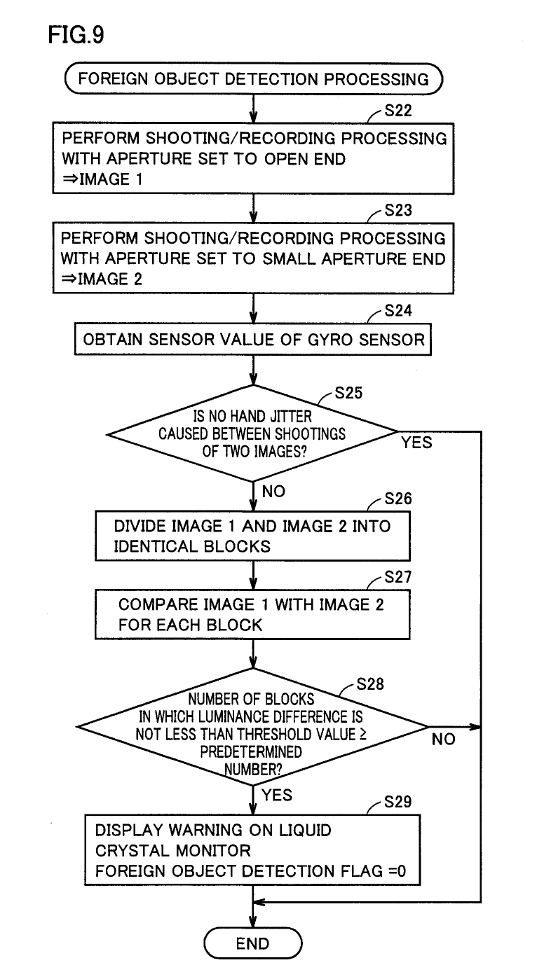

FIG. 9 is a flowchart illustrating foreign object detection processing in accordance with Embodiment 2 of the present invention. The flowchart of FIG. 9 is different from the flowchart of FIG. 3 only in that step S21 for moving the focus position to the proximate end portion is removed from the flowchart of FIG. 3. Specifically, in the foreign object detection processing in FIG. 9, shooting is continuously performed with the aperture changed while the focus position of optical lens 12 set for the ordinary shooting processing is maintained.

With such a configuration, according to the foreign object detection processing in accordance with Embodiment 2 of the present invention, although the subject is in focus both in image 1 and image 2, there is a difference in the degree of blurring in front of and in back of the subject between image 1 and image 2. Since a difference in brightness of the subject is therefore eliminated from the difference between image 1 and image 2, it is possible to prevent making an erroneous determination that a foreign object adheres.

### Embodiment 3

In Embodiments 1 and 2 described above, shooting is continuously performed with the aperture changed to the open end and the small aperture end after the ordinary shooting processing is completed. Similar effects can also be obtained when shooting is performed with the aperture changed from the state set for the ordinary shooting processing.

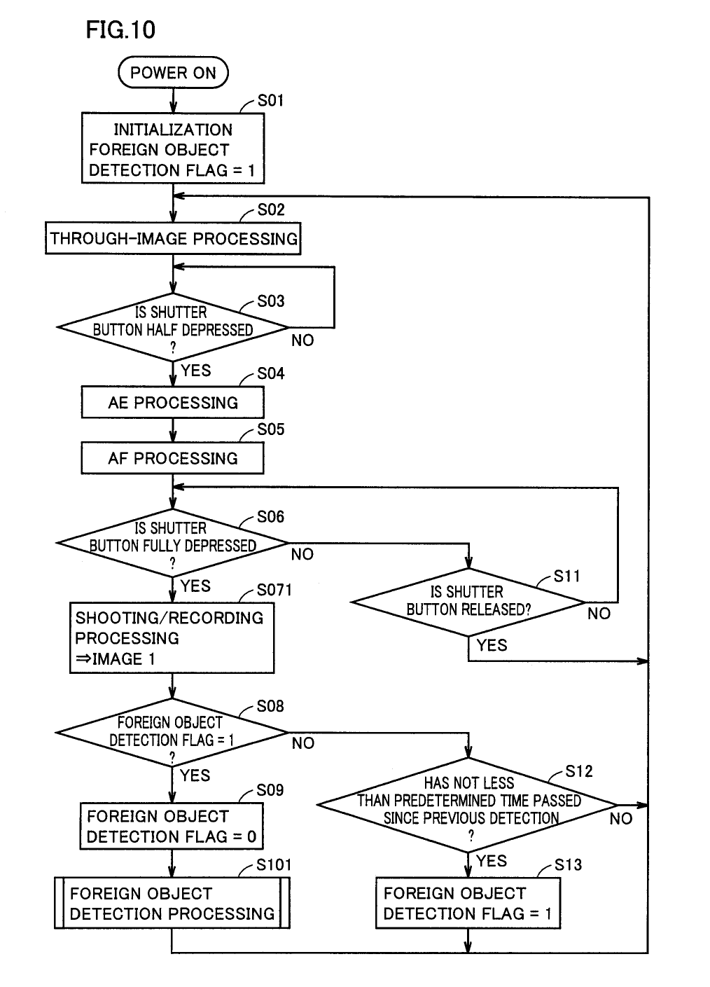

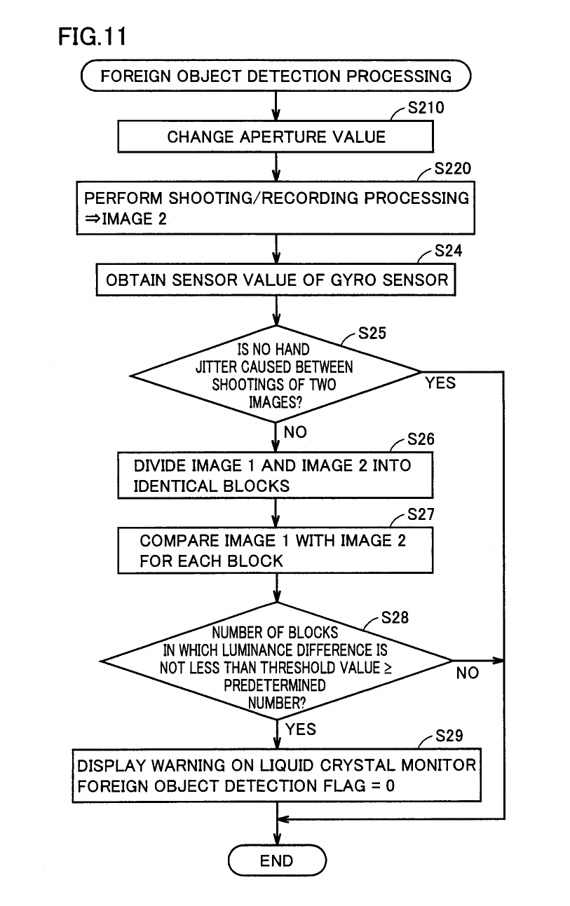

FIGS. 10 and 11 are flowcharts illustrating foreign object detection processing in accordance with Embodiment 3 of the present invention. A control program corresponding to the flowcharts is stored in flash memory 46.

The flowchart of FIG. 10 is different from the flowchart of FIG. 2 only in that steps S07, S10 in the flowchart of FIG. 2 are replaced by steps 5071, S101.

Referring to FIG. 10, in step S06, if shutter button 28 is fully depressed (YES in step S06), CPU 30 performs the shooting/recording processing (step S071). On this occasion, the raw image signal with a high resolution output from imaging element 16 is converted by AFE circuit 22 into raw image data, and the converted raw image data is written in SDRAM 34 through signal processing circuit 24. As a result, image data in the YUV format is temporarily stored in SDRAM 34. In the present embodiment, an image shot under ordinary shooting conditions will be referred to as “image 1”.

Then, in step S08, CPU 30 determines whether or not the foreign object detection flag indicates “1”. If the foreign object detection flag is “1” (YES in step S08), CPU 30 sets the foreign object detection flag to “0” (step S09) and performs foreign object detection processing for detecting a foreign object adhering to optical lens 12 (step S101).

The foreign object detection processing in step S101 follows a subroutine shown in FIG. 11. The flowchart of FIG. 11 is different from the flowchart of FIG. 3 only in that steps S21 to S23 in the flowchart of FIG. 3 are replaced by steps S210, S220.

Referring to FIG. 11, firstly, CPU 30 instructs driver 20 to change the aperture value of aperture mechanism 14 (step S210). In step S210, the aperture value is set from a current state to a state where the aperture is narrowed by a plurality of stages.

When the aperture is changed, the raw image signal based on pre-exposure after the change is output from imaging element 16. CPU 30 captures luminance evaluation values Iy[0] to Iy[64] based on the raw image signal from luminance evaluation circuit 50, and adjusts the exposure time based on the captured luminance evaluation values.

On this occasion, CPU 30 adjusts the exposure time such that the exposure value at the time of current shooting is substantially identical to the exposure value at the time of ordinary shooting in step 5071. Specifically, shooting conditions in step 5071 and shooting conditions in step S220 are set such that they use different combinations of aperture values and exposure times for achieving an appropriate exposure value in accordance with the brightness of the subject field.

When the optimal exposure time is adjusted with the changed aperture, CPU 30 performs the shooting/recording processing under the determined shooting conditions (step S220). The raw image signal output from imaging element 16 is converted by AFE circuit 22 into raw image data, and the converted raw image data is written in SDRAM 34 through signal processing circuit 24. On this occasion, in AFE circuit 22, gain adjustment is performed such that a shot image has brightness substantially identical to that of “image 1”. As a result, image data in the YUV format is temporarily stored in SDRAM 34. In the present embodiment, the shot image obtained when the aperture is changed will be referred to as “image 2”.

Therefore, in the present embodiment, the presence or absence of a foreign object adhering to optical lens 12 is determined by comparing “image 1” shot under the ordinary shooting conditions with “image 2” shot under the shooting conditions in which the aperture of the ordinary shooting conditions is changed. It is to be noted that the change of the aperture in step S210 is not limited to one of the open end and the small aperture end, as long as the change causes a significant difference in the influence of the foreign object between image 1 and image 2.

According to the foreign object detection processing in accordance with Embodiment 3 of the present invention, shooting is performed under the shooting conditions in which the aperture is changed while the focus position of optical lens 12 set for the ordinary shooting processing is maintained. Therefore, the subject is in focus both in image 1 and image 2, and a difference in brightness of the subject is eliminated from the difference between image 1 and image 2. As a result, it is possible to prevent making an erroneous determination that a foreign object adheres.

Further, since the number of performing shooting with the shooting conditions (aperture and exposure time) changed is reduced from two to one when compared with the foreign object detection processing in accordance with Embodiments 1 and 2 described above, processing load and processing time for the foreign object detection processing can be reduced. In addition, since it is possible to suppress a hand jitter image from being mixed into the obtained continuously shot images, detection accuracy of the foreign object detection processing can be enhanced.

### Embodiment 4

The two images with different apertures will now be compared. In either image, the outline and details of the subject are clearly depicted in an in-focus region, resulting in more edge portions, whereas the outline and details of the subject are blurred in an out-of-focus region, resulting in less edge portions. It is to be noted that an edge portion refers to a portion having a large difference in a gradation value between adjacent pixels that appears in an outline portion and the like of a subject in an image.

Accordingly, image 2 shot with the aperture narrowed has more edge portions as it has a larger in-focus region, and image 1 shot with the aperture opened has less edge portions as it has a smaller in-focus region. Therefore, if a luminance difference is caused between image 1 and image 2 due to a difference in the edge portions, there is a possibility that detection of the luminance difference may lead to an erroneous determination that a foreign object adheres.

Thus, in foreign object detection processing in accordance with the present embodiment, when image 1 and image 2 are compared, edge portions common to image 1 and image 2 are removed from the respective images, and thereby portions other than the edge portions are compared between image 1 and image 2.

Detection of the edge portions common to the images can be performed by detecting the edge portions in image 1, because the edge portions in image 1 shot with the aperture opened also serve as the edge portions in image 2 shot with the aperture narrowed.

According to the foreign object detection processing in accordance with Embodiment 4 of the present invention, the difference in the edge portions is eliminated from the difference between image 1 and image 2, and thus it is possible to prevent making an erroneous determination that a foreign object adheres.

### Embodiment 5

When optical lens 12 has a zoom function changing a shooting angle of view, it is necessary to set the shooting angle of view to be identical in the shooting conditions for image 1 and image 2, because depth of field is different depending on the shooting angle of view.

When shooting is performed with the shooting angle of view set to a wide angle side, the depth of field is generally increased, and thus the influence of the foreign object adhering to optical lens 12 on the shot image is relatively increased. Therefore, in foreign object detection processing in accordance with Embodiment 5 of the present invention, the shooting angle of view is further fixed to a predetermined value on the wide angle side in the shooting conditions for image 1 and image 2. This can cause a significant difference in the influence of the foreign object on the shot images between image 1 and image 2. As a result, detection accuracy of the foreign object detection processing can be enhanced.

Although Embodiments 1 to 5 described above describe configurations performing the foreign object detection processing after the ordinary shooting processing is completed, the foreign object detection processing may be performed before the ordinary shooting processing. For example, it may be performed when shutter button 28 is half depressed by a user, and may be performed along with the through-image processing.

Further, the embodiments described above describe configurations performing current foreign object detection processing when it is determined that not less than a predetermined time has passed since previous foreign object detection processing was performed, as a measure defining the degree of performing the foreign object detection processing, current foreign object detection processing may be performed when it is determined that the number of images shot since previous foreign object detection processing was performed reaches a predetermined number.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An imaging apparatus, comprising:
an imaging unit having an imaging surface on which an optical image of a subject field passing through a lens is emitted, which generates an image signal corresponding to the optical image of the subject field by photoelectric conversion;
an aperture control unit which controls an aperture of said lens;
a shutter unit which controls exposure time for said imaging unit;
an exposure adjustment unit which adjusts an exposure value for said imaging surface based on an evaluation value of brightness of the subject field;
a focus adjustment unit which adjusts a focus position of said lens; and
a foreign object detection unit which detects a foreign object adhering to said lens by performing shooting under a plurality of shooting conditions in which the exposure value and the focus position are identical and aperture values are different from each other, and comparing a plurality of the image signals obtained from said imaging unit during said shooting.

2. The imaging apparatus according to claim 1, wherein said foreign object detection unit includes
a computation unit which obtains a luminance difference between a first image signal and a second image signal having different shooting conditions, for each of a plurality of divided areas generated by dividing an image indicated by each of said first and second image signals,
a determination unit which determines whether or not the luminance difference obtained by said computation unit is not less than a threshold value set beforehand in at least a portion of the divided areas, and
a warning unit which determines that the foreign object adheres to said lens and outputs a warning if said determination unit determines that the luminance difference obtained by said computation unit is not less than said threshold value.

3. The imaging apparatus according to claim 2, wherein said computation unit obtains the luminance difference between said first image signal and said second image signal for each of the divided areas that remain after an edge portion common to said first image signal and said second image signal is removed from said plurality of divided areas.

4. The imaging apparatus according to claim 1, wherein said foreign object detection unit detects the foreign object adhering to said lens by comparing a first image signal obtained when performing the shooting under a first shooting condition in which the aperture is set to an open end in a settable range with a second image signal obtained when performing the shooting under a second shooting condition in which the aperture is set to a small aperture end in said settable range.

5. The imaging apparatus according to claim 1, further comprising a zoom adjustment unit which adjusts a shooting angle of view,
wherein said foreign object detection unit sets the shooting angle of view to be identical between said plurality of shooting conditions.

6. The imaging apparatus according to claim 1, further comprising a hand jitter detection unit which detects hand jitter during said shooting,
wherein said foreign object detection unit detects the foreign object adhering to said lens if a hand jitter amount detected by said hand jitter detection unit when said foreign object detection unit continuously performs the shooting under said plurality of shooting conditions is not more than a predetermined amount.
